(19) United States
(12) Patent Application Publication
(10) Pub. No.: US 2024/0410621 A1
(43) Pub. Date: Dec. 12, 2024

(54) CASCADE PHASE CHANGE MATERIAL (PCM) HEAT PUMP WATER HEATER

(71) Applicant: SMALL PLANET USA, LLC, Tumwater, WA (US)

(72) Inventors: Thomas A. Murgatroyd, Chewelah, WA (US); Bryan T. Perkins, Coeur d’Alene, ID (US); Albert H. Rooks, Olympia, WA (US); Hayes Zirnhelt, Victoria (CA)

(21) Appl. No.: 18/734,877

(22) Filed: Jun. 5, 2024

Related U.S. Application Data
(60) Provisional application No. 63/471,853, filed on Jun. 8, 2023.

(51) Int. Cl. F24H 15/375; F24H 4/02; F24H 7/04; F24H 15/227; F24H 15/238

(52) U.S. Cl. CPC F24H 15/375; F24H 4/02; F24H 7/0416; F24H 15/227; F24H 15/238; F24H 2240/01

(57) ABSTRACT

One embodiment provides a cascade phase change material (PCM) natural refrigerant heat pump system that includes multiple heat pumps. A heat exchanger is connected to the multiple heat pumps. A thermal battery bank including multiple PCM battery cells is connected to the heat exchanger in a closed loop. A circulator pump is connected to the heat exchanger and the multiple PCM battery cells.

### CROSS-REFERENCE TO RELATED APPLICATIONS

This application claims the priority benefit of U.S. Provisional Patent Application Ser. No. 63/471,853, filed on Jun. 8, 2023, which is incorporated herein by reference in its entirety.

### COPYRIGHT DISCLAIMER

A portion of the disclosure of this patent document may contain material that is subject to copyright protection. The copyright owner has no objection to the facsimile reproduction by anyone of the patent document or the patent disclosure as it appears in the patent and trademark office patent file or records, but otherwise reserves all copyright rights whatsoever.

### TECHNICAL FIELD

One or more embodiments relate generally to water heating systems, and in particular, to a cascade phase change material (PCM) heat pump water heater and systems.

### BACKGROUND

A conventional heat pump system sources heat from the air on the source side and transfers it to a refrigerant, such as R-410A, R-32. This refrigerant then cycles through a heat exchanger where it can heat the load side water to be pumped through a water system. Once in the water system, this water can serve several purposes: it can be pumped to a zone manifold for hydronic heat, cycled through a heat exchanger for hot water, or even pumped through a coil to supply a ducted system. A heat pump can also remove heat from the water system, cool the refrigerant, and supply the water system with cooling.

### SUMMARY

One embodiment provides a cascade phase change material (PCM) natural refrigerant heat pump system that includes multiple heat pumps. A heat exchanger is connected to the multiple heat pumps. A thermal battery bank including multiple PCM battery cells is connected to the heat exchanger in a closed loop. A circulator pump is connected to the heat exchanger and the multiple PCM battery cells.

Another embodiment provides a cascade PCM natural refrigerant heat pump system that includes multiple heat pumps connected in parallel. A heat exchanger is connected to the multiple heat pumps. A thermal battery bank including multiple PCM battery cells that are disposed in series and connected to the multiple heat pumps via the heat exchanger. The thermal battery bank and the heat exchanger are disposed in a closed loop. A circulator pump is connected to the heat exchanger and the multiple PCM battery cells.

Still another embodiment provides a cascade PCM natural refrigerant heat pump system that includes a pair of heat pumps connected in parallel. A heat exchanger is connected to the pair of heat pumps. A thermal battery bank including multiple PCM thermal battery cells disposed in series is connected to the pair of heat pumps via the heat exchanger. The thermal battery bank and the heat exchanger are disposed in a closed loop. A circulator pump is connected to the heat exchanger and the multiple PCM thermal battery cells in the closed loop.

These and other features, aspects and advantages of the one or more embodiments will become understood with reference to the following description, appended claims and accompanying figures.

### BRIEF DESCRIPTION OF THE DRAWINGS

For a fuller understanding of the nature and advantages of the embodiments, as well as a preferred mode of use, reference should be made to the following detailed description read in conjunction with the accompanying drawings, in which:

FIG. 1 illustrates a cascade phase change material (PCM) heat pump water heater system, according to some embodiments;

FIG. 2 illustrates the cascade PCM heat pump water heater system of FIG. 1 shown during the charging only mode, according to some embodiments;

FIG. 3 illustrates the cascade PCM heat pump water heater system of FIG. 1 shown during the discharging mode, according to some embodiments;

FIG. 4 illustrates the cascade PCM heat pump water heater system of FIG. 1 shown during charging while meeting load mode, according to some embodiments;

FIG. 5 illustrates a top perspective view of an example heat exchanger, according to some embodiments;

FIG. 6 illustrates a side view of the heat exchanger of FIG. 5, according to some embodiments; and

FIG. 7 illustrates a top view of the heat exchanger of FIG. 5, according to some embodiments.

### DETAILED DESCRIPTION

The following description is made for the purpose of illustrating the general principles of one or more embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

A description of example embodiments is provided on the following pages. The text and figures are provided solely as examples to aid the reader in understanding the disclosed technology. They are not intended and are not to be construed as limiting the scope of this disclosed technology in any manner. Although certain embodiments and examples have been provided, it will be apparent to those skilled in the art based on the disclosures herein that changes in the embodiments and examples shown may be made without departing from the scope of this disclosed technology.

Some embodiments relate generally to water heating systems, and in particular, to a cascade phase change material (PCM) heat pump water heater and systems. One embodiment provides a cascade phase change material (PCM) natural refrigerant heat pump system that includes multiple heat pumps. A heat exchanger is connected to the multiple heat pumps. A thermal battery bank including multiple PCM battery cells is connected to the heat exchanger in a closed loop. A circulator pump is connected to the heat exchanger and the multiple PCM battery cells.

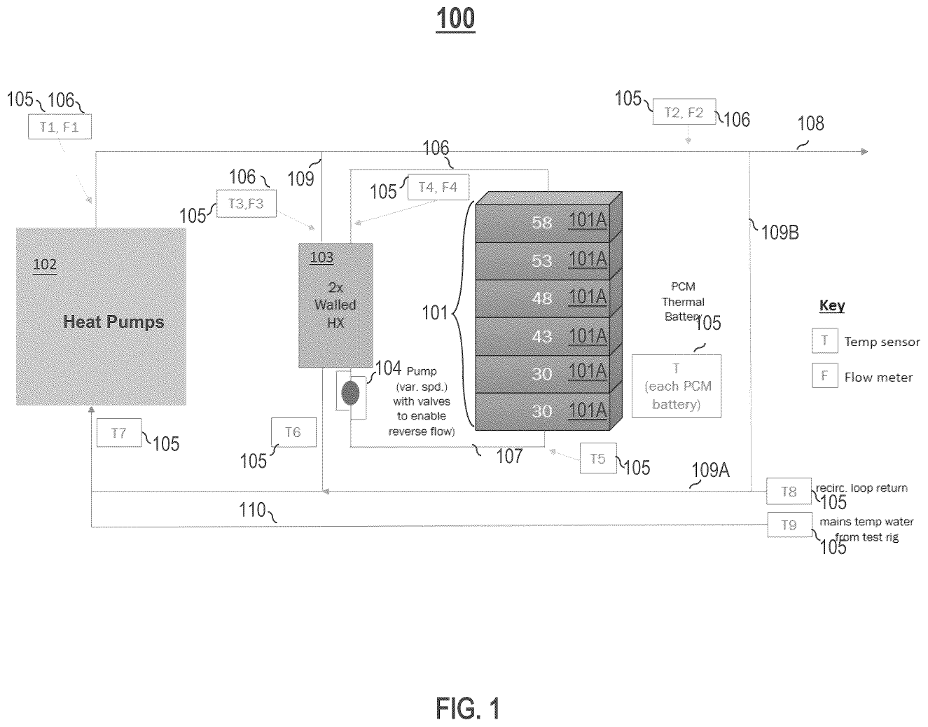

FIG. 1 illustrates a cascade phase change material (PCM) heat pump water heater system 100, according to some embodiments. In one or more embodiments, the system 100 includes a thermal battery bank 101 including, for example, six (6) stacked PCM battery cells 101A (thermal batteries), two heat pumps 102 (e.g., SANCO2™ heat pumps), a double walled heat exchanger 103, and a variable speed circulator pump 104 positioned along a closed loop 107 for the thermal battery bank 101. The PCM battery cells 101A are connected to the heat pumps 102 via the heat exchanger 103. In one embodiment, the cascade PCM heat pump is designed for natural refrigerants, such as carbon dioxide (CO₂) (R-744/R744) and propane (R-290/R290).

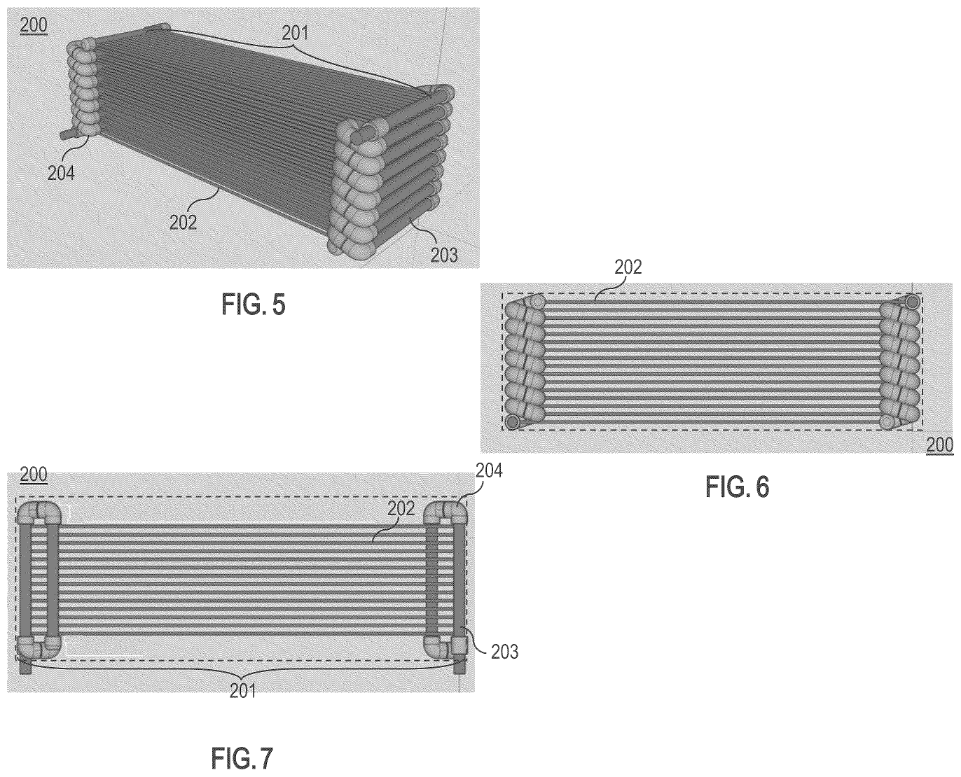

In some embodiments, each PCM battery cell 101A comprises an individual PCM filled enclosure containing a heat exchanger 200 (FIGS. 5-7) (e.g., a capillary tube heat exchanger, other type of tubing heat exchanger, etc.) connected to the closed loop 107. In one or more embodiments, the PCM battery cells 101A are connected in series. As described in detail below, in one embodiment, the PCM battery cells 101A include one or more PCMs 30, one or more PCMs 43, one or more PCMs 48, one or more PCMs 53, and/or one or more PCMs 58.

In one or more embodiments, the circulator pump 104 circulates water though the heat exchanger 103 to charge and discharge the thermal battery bank 101 based on controls (e.g., known technology, customized electronic controls, etc.) for the heat pumps 102 and a hot water draw profile. In some embodiments, the circulator pump 104 includes a set of solenoid valves and bypass plumbing that enables flow direction of water to be reversed to maintain counter flow through the heat exchanger 103.

In some embodiments, the system 100 further includes multiple temperature sensors 105 and flow meters 106 for recording temperature data and flow data, respectively, at different components and points of the system 100. For example, as shown in FIG. 1, temperature data may be recorded at each PCM battery cell 101A as well as at points T1-T9, and flow data may be recorded at points F1-F4. Any recorded data (i.e., temperature data and/or flow data) may be used for testing and control purposes.

In one or more embodiments, for testing purposes, the system 100 may be connected to a test rig (not shown) that both simulates domestic hot water load and provides incoming water to the system 100 at the following temperatures: a temperature of mains water (i.e., water flowing through a mains water line 110), and a temperature of recirculation return water (i.e., water flowing through a return line 109A of the recirculation loop 109).

In some embodiments, controls for the heat pumps 102 may be refined based on user input and recorded data. In one or more embodiments, initially, the controls for the heat pumps 102 may be configured as follows. First, the heat pumps 102 are configured to turn on when a state of charge of the thermal battery bank 101 drops to a pre-determined threshold value (e.g., 65%, etc.). The state of charge of the thermal battery bank 101 may be calculated as a running integral using recorded flow data and recorded temperature data.

In one or more embodiments, second, the heat pumps 102 are configured to turn off when the state of charge of the thermal battery bank 101 is fully charged. Fully charged may be defined based on a comparison between recorded temperature data at one or more PCM battery cells 101A and a pre-determined target value. For example, an initial value of 35° C. recorded at a PCM battery cell 101A (including a PCM 30) may be defined as fully charged (i.e., set as the pre-determined target value). Fully charged occurs in the context that if there was not a hot water draw, the equilibrium temperature of the thermal battery bank 101 overall does not result in any PCM battery cell 101A exceeding its maximum operating temperature.

In some embodiments, third, each PCM battery cell 101A including a PCM 30 must not exceed an operating temperature of 50° C. This may require an additional control feature (backup) to ensure this cannot occur in the event each PCM 30 is ‘overcharged’.

In one or more embodiments, the system 100 is configured to have multiple modes of operation (“operating modes”). For example, in some embodiments, the multiple operating modes include the following: (1) a charging only mode, (2) a discharging mode, and (3) a charging while meeting load mode.

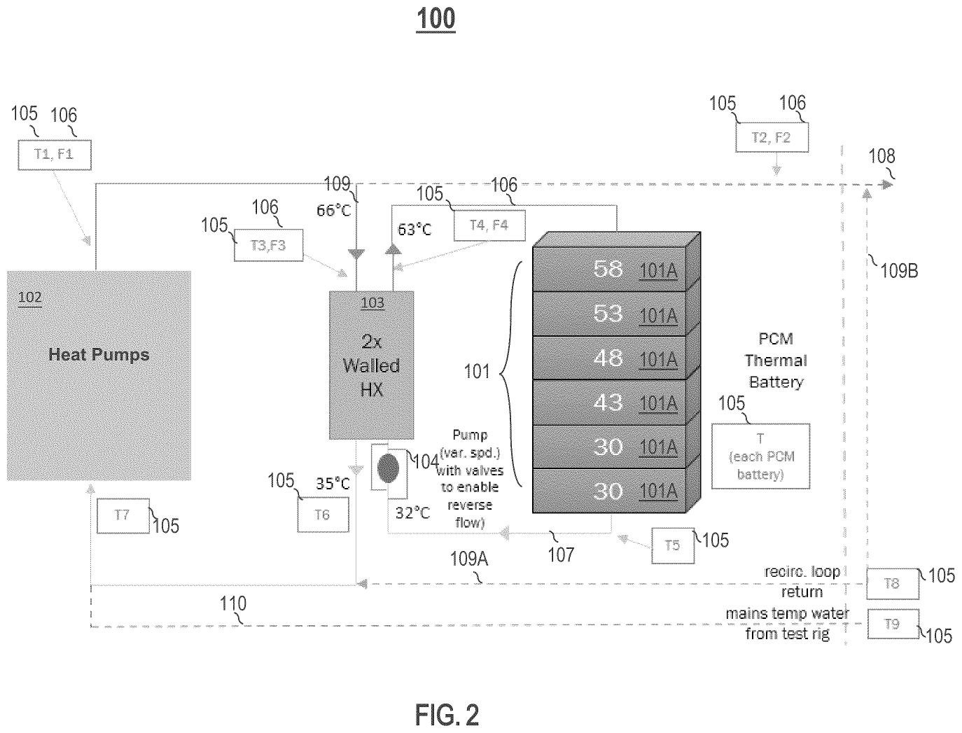

FIG. 2 illustrates the cascade PCM heat pump water heater system 100 of FIG. 1 shown during the charging only mode, according to some embodiments. As there is a continuous recirculation of hot water load in most systems, in some embodiments the charging only mode may occur only during initial start-up of the system 100. During the charging only mode, hot water produced by the heat pumps 102 runs through the heat exchanger 103 in a single pass, and returns to the heat pumps 102 at approximately 35° C. During the charging only mode, water is also circulated in the opposite direction (i.e., counter flow) through the closed loop 107 for the thermal battery bank 101. In one or more embodiments, during the charging only mode, the thermal battery bank 101 is expected to fully change phase in approximately 2.9 hours (at full thermal output of the heat pumps 102) with no hot water load.

In some embodiments, the controls for the heat pumps 102 are configured to trigger the charging only mode. For example, in some embodiments, the charging only mode is triggered based on a state of charge of the thermal battery bank 101. The state of charge of the thermal battery bank 101 is calculated as a running integral using recorded data (flow data and temperature data) at points T3, F3, and T2. During initial start-up of the system 100, the running integral should be zero, which in turn triggers the heat pumps 102 to turn on/start. Alternatively, a temperature setpoint in one of the PCM battery cells 101A may be used instead. Controls for the circulation pump 104 (on the closed loop 107 for the thermal battery bank 101) are configured such that the circulation pump 104 turns on based on operation of the heat pumps 102. Alternatively, the circulation pump 104 is configured to turn on based on the running integral used to calculate the state of charge of the thermal battery bank 101.

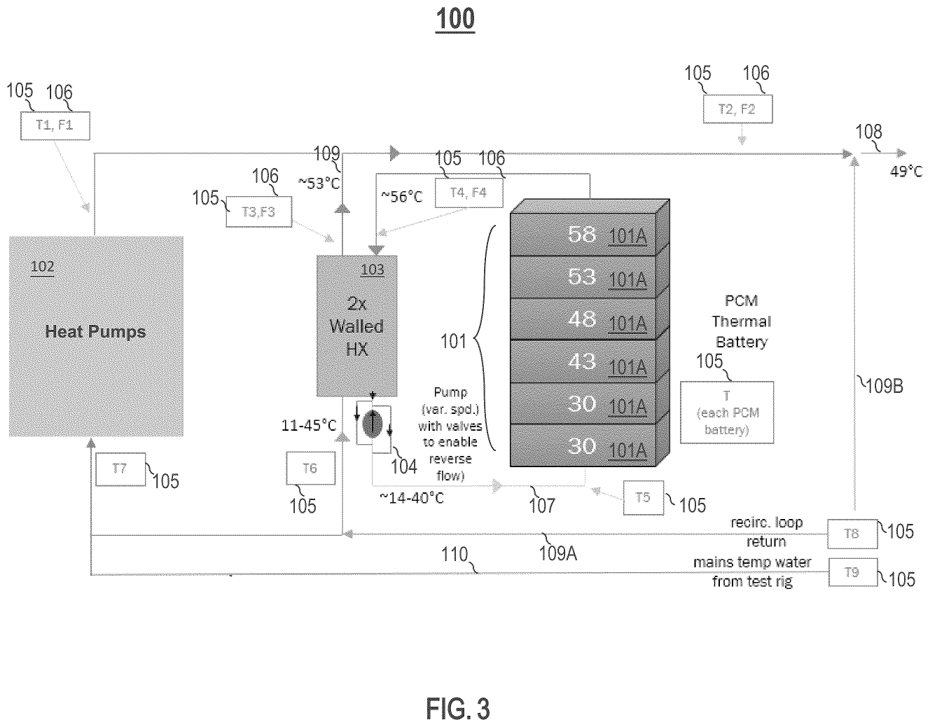

FIG. 3 illustrates the cascade PCM heat pump water heater system 100 of FIG. 1 shown during the discharging mode, according to some embodiments. In one or more embodiments, during the discharging mode, recirculation water (i.e., water flowing through the recirculation loop 109) and mains water (i.e., water flowing through the mains water line 110) are combined, run through the heat exchanger 103 in a single pass, and are heated up to a pre-determined target temperature of 49° C. for household delivery via a load line 108. During the discharging mode, water is also circulated in the opposite direction (i.e., counter flow) through the closed circulation loop 107 for the thermal battery bank 101. During the discharging mode, if the heat pumps 102 are triggered to turn on based on the state of charge of the thermal battery bank 101, the heat pumps 102 may also provide additional hot water to meet a hot water load (e.g., domestic hot water load).

In some embodiments, the controls for the heat pumps 102 are configured to invoke/trigger the discharging mode. For example, in one or more embodiments, the discharging mode is triggered when cold water flows through the heat exchanger 103, causing recorded temperature data at point T2 to drop below a pre-determined threshold value (e.g., initially 52° C., final value TBD) and the heat pumps 102 to turn on. Cold water may flow through the heat exchanger 103 as taps (at a building or household connected to the system 100) are opened or water is recirculated through heat exchanger 103. During the discharging mode, solenoid valves of the circulation pump 104 (on the closed loop 107 for the thermal battery bank 101) change position to reverse flow direction of water, therefore maintaining counter flow through the heat exchanger 103. During the discharging mode, the circulation pump 104 is configured to turn on, and match its flow rate of water with the flow rate of water through the heat exchanger 103. Alternatively, a temperature setpoint in one of the PCM battery cells 101A may be used instead, in accordance with user input. During the discharging mode, recirculation water (i.e., water flowing through the recirculation loop 109) and mains water (i.e., water flowing through the mains water line 110) flow through the heat exchanger 103 and the heat pumps 102 (if turned on) based on pressure from the mains water line and the recirculation loop pumps (i.e., supply side). In some embodiments, the coefficient of performance (COP) of the system 100 is maximized by maximizing the flow of mains water through the heat pumps 102 and maximizing the flow of recirculation water through the heat exchanger 103.

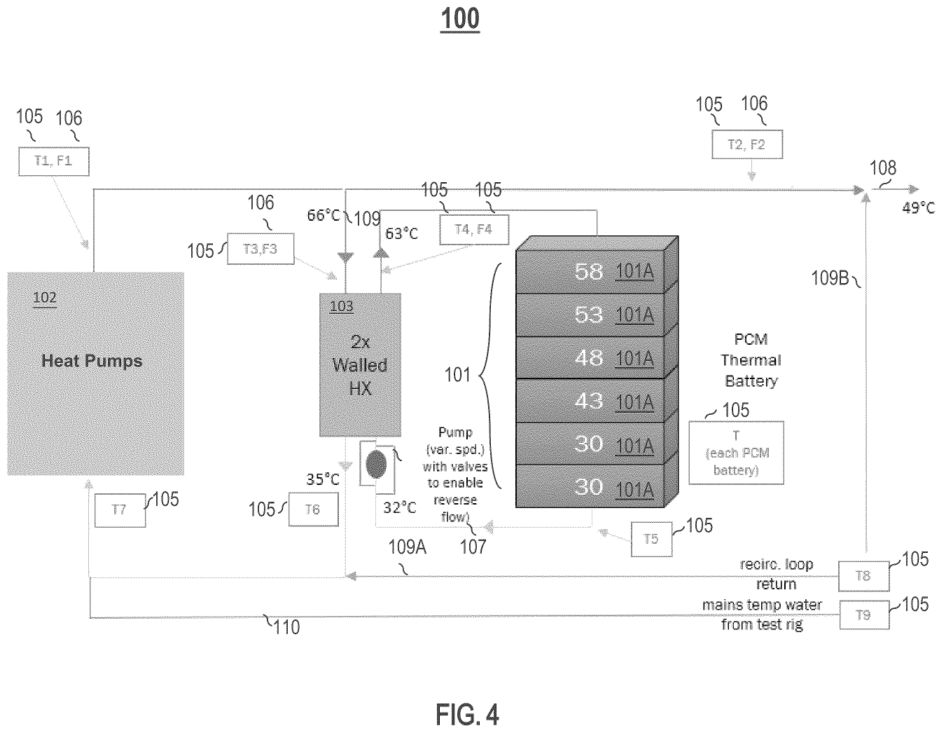

FIG. 4 illustrates the cascade PCM heat pump water heater system 100 of FIG. 1 shown during charging while meeting load mode, according to some embodiments. In one or more embodiments, during the charging while meeting load mode, hot water produced by the heat pumps 102 flows through the load line 108 and the recirculation loop 109 in sufficient quantities to meet a hot water load (e.g., domestic hot water load), while any remaining hot water output from the heat pumps 102 flows through the heat exchanger 103, therefore charging the thermal battery bank 101 (similar to the charging only mode). The hot water load is based on a temperature setpoint for the recirculation loop 109 and a hot water draw profile. The recirculation loop 109 splits as it returns to the system 100. Specifically, a branch/portion 109A of the recirculation loop 109 goes back to the heat pumps 102, such that recirculation water (i.e., water flowing through the recirculation loop 109) mixes with mains water (i.e., water flowing through the mains water line 110) and heat exchanger water (i.e., water flowing through the heat exchanger 103). A remaining branch/portion 109B of the recirculation loop 109 bypasses the system 100 to mix recirculation water with hot water output from the heat pumps 102, such that the resulting combination flows through the load line 108.

In some embodiments, the controls for the heat pumps 102 are configured to trigger the charging while meeting load mode. For example, in one or more embodiments, the charging while meeting load mode is triggered similar to how the charging only mode is triggered (i.e., based on the state of charge of the thermal battery bank 101). During the charging while meeting load mode, the circulation pump 104 (on the closed loop 107 for the thermal battery bank 101) varies speed to maintain equal flow rates on opposing sides of the heat exchanger 103. During the charging while meeting load mode, hot water draw (i.e., when taps are opened in a building or household connected to the system 100) causes mains water to flow through the heat pumps 102. In some embodiments, during the charging while meeting load mode, hot water leaving the system 100 is tempered using a tempering valve to maintain a pre-determined target temperature (e.g., starting value of 49° C., may be tested up to 53° C.) for delivery via the load line 108. During the charging while meeting load mode, the recirculation loop pumps (i.e., supply side) create minimum flow through the recirculation loop 109, and extra flow from the heat pumps 102 causes flow through the heat exchanger 103.

In some embodiments, for testing purposes involving the test rig, flow to the load line 108 and the recirculation loop 109 may be controlled by a flow control valve to ensure enough back pressure, such that hot water recirculates through the heat exchanger 103 for charging the thermal battery bank 101. Alternatively, a pump can be added to a branch/portion connected to the heat exchanger 103.

Table 1 below provides examples of different PCMs used as the PCM battery cells 101A, in one or more embodiments.

| Battery cell # | Label | PCM product |
|---|---|---|
| 1 | 58 | InsolCorp PCM 58 |
| 2 | 53 | InsolCorp PCM 53 |
| 3 | 48 | InsolCorp PCM 48 |
| 4 | 43 | InsolCorp PCM 43 |
| 5 | 30 | Axiotherm ATS 30 (maximum operating |
| | | temperature of 50° C.) |
| 6 | 30 | Axiotherm ATS 30 (maximum operating |
| | | temperature of 50° C.) |

FIG. 5 illustrates a top perspective view of an example heat exchanger 200, according to some embodiments. FIG. 6 illustrates a side view of the heat exchanger 200 of FIG. 5, according to some embodiments. FIG. 7 illustrates a top view of the heat exchanger 200 of FIG. 5, according to some embodiments. In one or more embodiments, each PCM battery cell 101A (FIGS. 1-4) includes a heat exchanger 200 (e.g., a capillary tube-based heat exchanger, other types of tube-based heat exchangers, etc.). As shown in FIGS. 5-7, in some embodiments the heat exchanger 200 includes, for example, sixteen (16) tubing portions 201. In one or more embodiments, each tubing portion 201 includes, for example, fourteen (14) capillary tubes 202 spaced apart (e.g., 15 mm, etc.). In some embodiments, the tubing portions 201 are stacked with, for example, a 50 mm (or other distance) stagger (horizontal offset between consecutive tubing portions 201) to achieve a desired vertical spacing of, for example, 15 mm (or other distance) between capillary tubes 202. In one or more embodiments, each header 203 of each tubing portion 201 is connected through 90° elbow fittings 204 to achieve a compact form and desired spacing. In some embodiments, the heat exchanger 200 is designed for reverse-return for even heat transfer. In one or more embodiments, outer dimensions of the heat exchanger 200 are substantially about 235 mm in width, substantially about 252 mm in height, and substantially about 760 mm in length.

In some embodiments, sides of the heat exchanger 200 include a void (e.g., 40 mm, etc.). In one or more embodiments, each void may be filled with, for example, 25 mm (1″) nominal cork insulation sealed with an R-guard membrane (or equivalent), and the remainder (approximately 15 mm) filled with PCM. In some embodiments, the heat exchanger 200 tubing may be made of metal (e.g., copper, aluminum, stainless steel, etc.) or other appropriate materials.

While certain exemplary embodiments of a cascade PCM heat pump water heater have been described and shown in the accompanying figures, it is to be understood that such embodiments are merely illustrative of and not restrictive on the broad embodiments, and that the embodiments not be limited to the specific constructions and arrangements shown and described, since various other modifications may occur to those ordinarily skilled in the art. The description and figures are provided solely as examples to aid the reader in understanding the embodiments. The description and figures are not intended, and are not to be construed, as limiting the scope of the embodiments in any manner. Although certain embodiments and examples have been provided, it will be apparent to those skilled in the art based on the disclosures herein that changes in the embodiments and examples shown may be made without departing from the scope of the inventive embodiments.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the disclosed technology. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the embodiments has been presented for purposes of illustration and description, but is not intended to be exhaustive or limited to the embodiments in the form disclosed. Many modifications and variations will be apparent to those of ordinary skill in the art without departing from the scope and spirit of the disclosed technology.

Though the embodiments have been described with reference to certain versions thereof; however, other versions are possible. Therefore, the spirit and scope of the appended claims should not be limited to the description of the preferred versions contained herein.

What is claimed is:

1. A cascade phase change material (PCM) natural refrigerant heat pump system comprising:
a pair of heat pumps;
a heat exchanger coupled to the plurality of heat pumps;
a thermal battery bank including a plurality of PCM battery cells coupled to the heat exchanger in a closed loop; and
a circulator pump coupled to the heat exchanger and the plurality of PCM battery cells.

2. The system of claim 1, further comprising heat pump controls and a plurality of temperature sensors that are each disposed within the system at multiple locations that record temperature data.

3. The system of claim 1, further comprising heat pump controls and a plurality of flow meters that are each disposed within the system at multiple locations that record flow data.

4. The system of claim 1, wherein the natural refrigerant is carbon dioxide (CO₂).

5. The system of claim 1, wherein the circulator pump is a variable speed circulator pump including a set of valves and bypass plumbing, and the variable speed circulator pump enables water flow direction reversal to maintain flow through the heat exchanger.

6. The system of claim 1, wherein each of the plurality of PCM battery cells are individual PCM filled enclosures including a tube-based heat exchanger coupled to the closed loop.

7. The system of claim 6, wherein each tube-based heat exchanger comprises a plurality of tubing portions.

8. The system of claim 7, wherein each tube portion comprises a plurality of spaced apart tubes and a plurality of headers.

9. The system of claim 7, wherein each tube-based heat exchanger is configured for reverse return that provides even heat transfer.

10. A cascade phase change material (PCM) natural refrigerant heat pump system comprising:
a plurality of heat pumps coupled in parallel;
a heat exchanger coupled to the plurality of heat pumps;
a thermal battery bank including a plurality of PCM battery cells disposed in series and coupled to the plurality of heat pumps via the heat exchanger, wherein the thermal battery bank and the heat exchanger are disposed in a closed loop; and
a circulator pump coupled to the heat exchanger and the plurality of PCM battery cells.

11. The system of claim 10, further comprising:
heat pump controls coupled to the plurality of heat pumps;
a plurality of temperature sensors coupled to the controls, each of the plurality of temperature sensors are disposed within the system and record temperature data; and
a plurality of flow meters coupled to the controls, each of the plurality of flow meters are disposed within the system and record flow data.

12. The system of claim 10, wherein the natural refrigerant is one of carbon dioxide (CO₂) or propane.

13. The system of claim 10, wherein the circulator pump is a variable speed circulator pump including a set of solenoid valves and bypass plumbing, and the variable speed circulator pump enables water flow direction reversal to maintain flow through the heat exchanger.

14. The system of claim 10, wherein:
each of the plurality of PCM battery cells are individual PCM filled enclosures including a tube-based heat exchanger coupled to the closed loop;
each tube-based heat exchanger comprises a plurality of tubing portions;
each tubing portion comprises a plurality of spaced apart tubes and a plurality of headers; and
each tube-based heat exchanger is configured for reverse return that provides even heat transfer.

15. A cascade phase change material (PCM) natural refrigerant heat pump system comprising:
a pair of heat pumps coupled in parallel;
a heat exchanger coupled to the pair of heat pumps;
a thermal battery bank including a plurality of PCM thermal battery cells disposed in series and coupled to the pair of heat pumps via the heat exchanger, wherein the thermal battery bank and the heat exchanger are disposed in a closed loop; and
a circulator pump coupled to the heat exchanger and the plurality of PCM thermal battery cells in the closed loop.

16. The system of claim 15, further comprising:
heat pump controls coupled to the pair of heat pumps.

17. The system of claim 16, further comprising:
a plurality of temperature sensors coupled to the controls, each of the plurality of temperature sensors are disposed within the system and record temperature data; and
a plurality of flow meters coupled to the controls, each of the plurality of flow meters are disposed within the system and record flow data.

18. The system of claim 15, wherein the natural refrigerant is one of carbon dioxide (CO₂) or propane.

19. The system of claim 15, wherein the circulator pump is a variable speed circulator pump including a set of solenoid valves and bypass plumbing, and the variable speed circulator pump enables water flow direction reversal to maintain flow through the heat exchanger.

20. The system of claim 15, wherein:
each of the plurality of PCM thermal battery cells are individual PCM filled enclosures including a tube-based heat exchanger coupled to the closed loop;
each tube-based heat exchanger comprises a plurality of tubing portions;
each tubing portion comprises a plurality of spaced apart tubes and a plurality of headers; and
each tube-based heat exchanger is configured for reverse return that provides even heat transfer.
